(19) United States
(12) Patent Application Publication
(10) Pub. No.: US 2007/0184971 A1
(43) Pub. Date: Aug. 9, 2007

(54) Thermally Stable Catalyst and Process for the Decomposition of Liquid Propellants

(75) Inventors: Mark D. Fokema, Framingham, MA (US); James E. Torkelson, Foxboro, MA (US)

Correspondence Address: MINTZ, LEVIN, COHN, FERRIS, GLOVSKY;AND POPEO, P.C., ONE FINANCIAL CENTER, BOSTON, MA, 02111, US

(73) Assignee: ASPEN PRODUCTS GROUP, Marlborough, MA (US)

(21) Appl. No.: 11/457,985

(22) Filed: Jul. 17, 2006

Related U.S. Application Data
(63) Continuation of application No. 11/389,527, filed on Mar. 24, 2006.
(60) Provisional application No. 60/666,274, filed on Mar. 28, 2005.

(51) Int. Cl. B01J 27/22; B01J 23/00; B01J 23/40; B01J 23/08

(52) U.S. Cl. 502/177; 502/300; 502/302; 502/349; 502/355; 502/304; 502/325; 502/326

(57) ABSTRACT

A robust, high-temperature catalyst comprising a catalytic component supported on a porous ceramic carrier is provided for propellant decomposition. The catalyst comprises a porous, high-surface-area ceramic carrier material and up to 40% of metal and/or metal oxide, based upon the total weight of the catalyst. The supported species include metals and/or oxides of transition and lanthanide metals that possess high activity for the decomposition of liquid propellants. The carrier can be produced via a wet chemical process and then impregnated with salt solutions containing desired active-phase precursors. The catalyst can cause a liquid propellant to react upon contact with the catalyst and to produce hot gases that can be used to provide thrust, drive turbines, inflate devices, etc.

### RELATED APPLICATION

This application is a continuation in part of U.S. application Ser. No. 11/389,527, filed on Mar. 24, 2006, the entire teachings of which are incorporated herein by reference. This application also claims the benefit of U.S. Provisional Application No. 60/666,274, filed on Mar. 28, 2005, the entire teachings of which are incorporated herein by reference.

### GOVERNMENT SUPPORT

This invention was made with Government support under Contract F33615-01-C-5200 awarded by the US Air Force Research Laboratory. The Government has certain rights in the invention.

### BACKGROUND

Liquid propellants that react to produce large volumes of low-molecular-weight gases are used in a variety of propulsion and gas-generator applications. A monopropellant is a stable single-phase liquid that includes both an oxidizer and a fuel. A bipropellant system makes use of two liquid reactants—one that acts as an oxidizer and one that acts as a fuel. Reactions within monopropellant and bipropellant systems are often initiated by passing the propellant over a heterogeneous catalyst.

Safer, less-toxic propellants that improve operational capabilities have long been sought by propulsion and gas-generator interests. Replacements for hydrazine-based propellants are of particular interest due to the flammability and toxicity of hydrazine.

Hydroxylammonium-nitrate-(HAN)-based monopropellants typically include water, HAN and one or more fuels. They offer numerous advantages over conventional monopropellant formulations. HAN-based monopropellants exhibit lower toxicity, lower flammability, lower vapor pressure, lower freezing-point temperature and higher density-specific impulses than hydrazine-based monopropellants. Hydrogen-peroxide-based monopropellants also offer many advantages over hydrazine-based monopropellants.

Monopropellants can be decomposed by passing them over a catalyst. The catalyst bed decomposes the monopropellant to produce a hot stream typically including steam, nitrogen, carbon dioxide, carbon monoxide and hydrogen. The hot gases can be used to provide thrust, drive turbines, inflate devices, and the like. The rate of gas production can be easily controlled by regulating the flow of propellant to the catalyst.

In propulsion applications, monopropellants are generally decomposed in systems comprising a pressurization system, a propellant tank, a fuel valve, a catalyst chamber and a nozzle. Such a system is operated by pressurizing the monopropellant and controlling the flow of the pressurized propellant to the catalyst chamber via the fuel valve. When the fuel valve is open, the propellant is expelled into the chamber and onto the catalyst bed where the propellant decomposes exothermically into lower-molecular-weight gases. Propulsion is achieved by depressurizing the hot gaseous product through the nozzle.

The high-adiabatic-decomposition-temperatures of HAN-based and hydrogen-peroxide-based propellants render conventional decomposition catalysts ineffective when applied to these monopropellant formulations. HAN-based monopropellant blends, such as AF-M315E and LGP 1846, possess theoretical adiabatic flame temperatures of 1810 and 2196° C., respectively, whereas monopropellants, such as hydrazine and 98% hydrogen peroxide, possess adiabatic flame temperatures of only 900 and 950° C., respectively. Monopropellants composed of hydrogen peroxide, water and ethanol exhibit flame temperatures ranging from 1443 to 1727° C. Metallic catalysts can initiate the decomposition of HAN-based and hydrogen-peroxide-based monopropellants; but conventional catalysts, such as Ir/A₂O₃ and Pt/A₂O₃ (commercially available as Shell 405, S-405, LCH-207 and LCH-210 catalysts) severely sinter and deactivate at the decomposition temperatures produced by these advanced monopropellants. Additionally, during the decomposition of these monopropellants, oxidizing species are produced that can further reduce the stability of the noble metals included in conventional catalysts. After short periods of operation with high-adiabatic-decomposition-temperature propellants, conventional catalysts are rendered ineffective.

Thus, catalysts that are able to initiate monopropellant decomposition reactions at low temperatures, while maintaining physical and chemical stability at temperatures above 1000° C., are needed for advanced propulsion and gas-generation systems.

### SUMMARY

There is provided an improved liquid-propellant-decomposition catalyst comprising a metal (acting as a catalytic component) dispersed on the surface of a thermally stable porous ceramic carrier. In order to provide sufficient catalytic activity, thermal stability and chemical stability, the metal may be combined with other elements to produce a metal alloy with increased catalytic reactivity, increased oxidation resistance, decreased vapor pressure, increased melting temperature and/or increased boiling temperature relative to that of the metal.

In an alternative embodiment, there is provided an improved liquid-propellant-decomposition catalyst comprising a metal-oxide species (as a catalytic component) dispersed on the surface of a thermally stable porous ceramic carrier. In order to provide sufficient catalytic activity, thermal stability and chemical stability, the metal oxide may be combined with other elements to produce a mixed-metal-oxide or complex-oxide phase with increased catalytic reactivity, decreased vapor pressure, increased melting temperature and/or increased boiling temperature relative to that of the metal oxide. Additional metallic components may also be added to the catalyst in order to increase the thermal conductivity of the catalyst.

The thermally stable porous ceramic carrier may be a metal oxide or metal carbide with a surface area greater than 1 m²/g. Preferably, the thermally stable porous ceramic carrier retains a surface area greater than 1 m²/g following exposure to an oxidizing environment at temperatures of 1650° C. and above. Carriers, described herein, can retain the recited high surface area at the specified temperature through at least one minute of exposure to the oxidizing environment. In particular embodiments, the high surface area is retained even after an exposure lasting at least 30 minutes.

In a process for the production of the liquid-propellant-decomposition catalysts, a thermally stable, porous ceramic carrier is produced via a wet chemical process in which chemical precursors are dissolved in a solvent. Additional reactants or catalysts that cause the precursors to come out of solution via gelation or precipitation are added to the solution. Solvent is removed from the sample, and the sample is heated in a controlled atmosphere to produce the desired ceramic phase. The carrier is then repeatedly impregnated with salt solutions including desired active-phase precursors, such as metal nitrates, metal chlorides and the like. Thermal treatment procedures between impregnations and following the final impregnation are conducted to produce a catalyst with a highly dispersed active phase of the desired composition. The catalyst can also be formed via a wet chemical process in which all the precursors for the thermally stable ceramic carrier and the supported phases are mixed in solution, removed from solution via gelation or precipitation, dried and heated.

The catalysts, when contacted with the liquid propellant, readily initiate and sustain the decomposition of liquid propellants into low-molecular-weight species. The catalysts are true catalysts in that they exhibit their catalytic effects with no chemical change taking place in the catalyst, itself, during the decomposition reaction.

A major advantage of embodiments of the catalyst over previous catalysts is that they can provide improved physical durability and catalytic stability at high propellant-decomposition temperatures. This high-temperature durability and stability enables the catalyst to be used in applications where long-term or repeated pulse-operation is desired. The retention of sufficient catalytic surface area in this catalyst at a temperature of 1650° C. or greater may be viewed as surprising in the sense that this temperature may exceed 90% of the melting temperature of the catalyst carrier.

An additional advantage of the catalyst is that it can offer improved catalytic activity for liquid-propellant decomposition relative to conventional hydrazine decomposition catalysts. The improved catalytic activity is evidenced by initiation of propellant decomposition reactions at a reduced temperature and is attributable to the unique composition and high surface area of the catalyst.

Another advantage of the catalyst is that it can be produced at a reduced cost relative to conventional hydrazine decomposition catalysts. Whereas pre-existing catalysts generally include loadings of greater than 20 weight-% precious metals, the subject catalyst can exhibit high reactivity at reduced precious metal content.

These and other advantages and attainments of the present invention will become apparent to those skilled in the art upon a reading of the following detailed description and illustrative embodiment of the invention.

### BRIEF DESCRIPTION OF THE DRAWINGS

In the course of the following detailed description, reference will be made to the attached drawings in which:

FIG. 1 is a cross-sectional view showing selected elements of hardware in which the catalyst is contained, and which can be use to decompose a liquid propellant to provide thrust.

FIG. 2 is a plot of gas pressure and gas temperature realized during catalytic propellant decomposition.

FIG. 3 is a plot of gas pressure, gas temperature and thruster external surface temperature realized during catalytic propellant decomposition.

FIG. 4 is a plot of thruster impulse repeatability through a set of twenty injections of monopropellant

### DETAILED DESCRIPTION

The catalysts of this disclosure can be formulated in several different ways in order to provide the catalytic activity and high-temperature stability that enables their successful use in liquid propellant applications. The presence of one or more metals selected from Ag, Au, Co, Cr, Cu, Fe, Ir, Mn, Ni, Os, Pd, Pt, Re, Ru, Rh, and V (in a metallic state) can promote the decomposition of HAN-based monopropellant blends. Further, because several of these metals are not thermally or chemically stable at the conditions produced by monopropellant decomposition, the metals can be combined with other metals, such as Ag, Al, Au, Ba, Ca, Ce, Co, Cr, Cu, Dy, Er, Eu, Fe, Gd, Hf, Ho, Ir, La, Lu, Mg, Mn, Mo, Nb, Nd, Ni, Os, Pd, Pr, Pt, Re, Ru, Rh, Sc, Sm, Sr, Ta, Tb, Ti, Tm, V, W, Y, Yb, Zr and mixtures thereof, to form alloys possessing enhanced stability without significantly reducing catalytic activity. In some cases, incorporating additional metallic or oxidic species may also increase catalytic reactivity.

The presence of one or more oxides selected from oxides of Al, Ce, Co, Cr, Cu, Dy, Er, Eu, Fe, Gd, Hf, Ho, La, Lu, Mg, Mn, Nb, Nd, Ni, Pr, Sc, Sm, Tb, Ti, Tm, V, Y, Yb, Zr and mixtures thereof can promote the decomposition of HAN-based monopropellant blends. The oxides can be mixed with other oxide compositions to improve the thermal or chemical stability of the catalyst at the conditions produced by monopropellant decomposition. In some cases, incorporating additional oxidic species may also increase catalytic reactivity.

By dispersing these active phases on a thermally stable, porous ceramic carrier, a large number of surface-active sites are exposed; and a catalyst with a high specific reactivity, defined as moles of propellant decomposed per unit mass catalyst per unit time, is realized. The inventive catalysts may include from 0.05 to 40% of active phase material based upon the total weight of the catalyst.

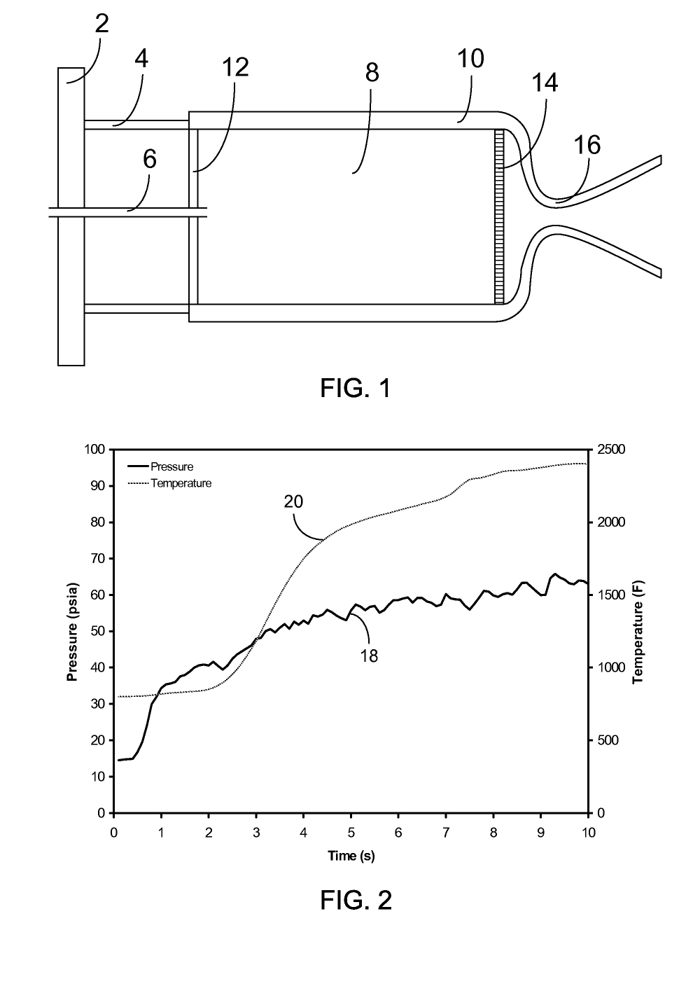

The catalyst can be utilized in conjunction with propellant and propellant decomposition hardware in order to produce hot gases that can be used to provide thrust, drive turbines, inflate devices, and the like. FIG. 1 provides an illustration of catalyst use within hardware designed to provide thrust from a monopropellant. The system generally comprises a mounting plate 2, thermal standoff 4, monopropellant injector 6, catalyst bed 8, reaction chamber 10, retaining plates 12, 14 and nozzle 16. The catalyst bed 8 fills the volume in the reaction chamber 10 (while providing passages for fluid flow there through) between plates 12, 14 at either end of the catalyst bed 8 and is secured therein by the plates 12, 14. The monopropellant is injected into the reaction chamber where the catalyst initiates decomposition reactions to produce hot gases, such as steam, nitrogen, carbon dioxide, carbon monoxide, hydrogen, oxygen and/or ammonia. The voluminous gas stream is ejected from the reaction chamber 10 through the nozzle 16, providing thrust.

In addition to exhibiting high reactivity and stability, it is advantageous for the catalyst to possess high mechanical strength and thermal conductivity in order to function well in practical applications. The high mechanical strength allows the catalyst to withstand the stresses imposed by the hot gases generated within the catalyst and passing over the surface of the catalyst. The thermal conductivity of the propellant decomposition catalyst plays a role in distributing the heat generated by the exothermic decomposition reaction throughout the catalyst bed. A catalyst comprising a low loading of metal on a porous ceramic carrier or a metal oxide supported on a porous ceramic carrier may not exhibit sufficient thermal conductivity. An additional thermally conductive metallic phase may be added to the catalyst (as described, e.g., in Example 9, infra). Conductive metallic phases that can be added include Co, Cr, Fe, Ir, Mo, Nb, Ni, Os, Pd, Pt, Re, Ru, Rh, Ta, V, W and mixtures thereof.

The selection and processing of the porous ceramic carrier play an important role in determining the stability and activity of the catalyst. Carriers that are able to retain a high surface area in an oxidizing environment at temperatures above 1400° C. are preferred. Examples of suitable carriers include metal hexaaluminates, aluminas, lanthanide oxides, metal zirconates, metal hafnates and metal carbides. Metal oxide-based carriers have generally not been applied to catalytic processes at temperatures above 1600° C. because thermally induced sintering reduces the carrier surface area below values practical for catalytic applications. While the slow anisotropic crystalline growth of metal hexaaluminates has allowed the production of useful carriers at temperatures up to 1600° C., little investigation of this material above 1600° C. has been conducted.

The carrier-active-catalytic phase combination and proportions are selected to minimize carrier-catalyst interactions that could reduce carrier stability and/or catalyst activity. At the temperatures of relevance for propellant decomposition, reaction of the supported phase with the carrier can easily occur, forming unwanted compounds of reduced catalytic utility. For instance, at high loadings, vanadium oxide can leach barium out of barium hexaaluminate to produce highly sinterable α-alumina.

In one embodiment of the present invention, barium hexaaluminate is used as the porous ceramic carrier. The carrier can be prepared by the base-catalyzed hydrolysis of aluminum sec-butoxide and barium methoxyethoxide in methoxyethanol. By removing the solvent at a temperature and pressure above the supercritical point of methoxyethanol, a needle-like microstructure is developed that provides increased ability to resist sintering as the carrier is heated. Particular processes for producing such a carrier are outlined in Examples 1 and 2, infra.

The inventive catalyst can be prepared in various ways. One suitable method comprises impregnating the porous carrier with solutions of precursors to the phases desired to be present in the final catalyst. The impregnation can be carried out with multiple solutions including different precursors, or with a single solution including multiple precursors. The impregnation can be carried out by adding to the porous carrier enough solution to fill the pores, then drying and calcining. Alternatively, the impregnation can be carried out by soaking the porous carrier in an excess of solution from which the required amounts of precursors are adsorbed by the carrier, after which the porous carrier is dried and calcined. Better results are obtained by repeatedly impregnating the porous carrier with precursor solutions of lower concentrations followed by drying and calcining. By using solutions with low precursor concentrations, highly dispersed metal and metal-oxide precursors are deposited on the porous carrier. Drying and calcining prior to the next impregnation step fixes the metal or metal oxide to the carrier and prevents redissolution of the precursor into the impregnating solution during the subsequent impregnation step. Repeated impregnation steps may also be conducted when it is desired to deposit larger amounts of the active catalytic species onto the porous carrier. Solutions of the precursors may be made up in alcohol, water, or other suitable solvents. Additional details for producing embodiments of the catalysts are found in the Examples, infra.

Any soluble form of the desired precursor can be employed in making the catalysts. In particular embodiments, the catalyst is one that can be decomposed to the metal by heating at a temperature below 600° C. or those that can be converted to the metal oxide by heating at a temperature below 600° C. Nitrates, chlorides, alkoxides and the like are examples of suitable precursors.

The porous carrier containing the solution of precursors can be dried by heating in an oxidizing, reducing or inert atmosphere. The dried impregnated carrier can then be heated to produce the desired active phase and to thermally condition the catalyst prior to use for propellant decomposition. Heating in an oxidizing atmosphere, in a reducing atmosphere and/or in an inert atmosphere to different temperatures may be conducted to retain the desired porous carrier characteristics, to produce the desired active catalytic phase and/or to produce the desired metal phase for thermal conductivity promotion. Parameters such as atmosphere, heating rate and duration of the heat treatment influence the properties of the final product.

The catalyst can also be produced by forming the porous carrier and supported phases at the same time in a wet chemical process. Carrier and supported-phase precursors, such as metal alkoxides, metal nitrates, metal chlorides, and the like, can be dissolved in a solvent, such as alcohol, and hydrolyzed with water in the presence of a catalyst to produce a gel or precipitate that can be collected, dried and heated to produce a catalyst of the desired composition.

The catalyst should retain a surface area in excess of 10 m²/g when heated in an oxidizing atmosphere at 1400° C. for more than one hour. Alternatively, the catalyst should retain a surface area in excess of 1 m²/g when heated in an oxidizing atmosphere at 1650° C. for more than one hour. The catalyst may be in the form of granules, pellets or structured elements, such as monoliths or foams.

The catalyst can be used in practice by placing the catalyst into an enclosure equipped with inlet and outlet connections. It is advantageous to maintain the catalyst at a temperature between −100 and 400° C. prior to introduction of the propellant. Propellant is admitted to the catalyst via the enclosure inlet. Propellant flows through the porous catalyst, reacts to form low molecular weight gases and exits the system through the enclosure outlet. The propellant and gaseous product may pass around catalyst particles, and/or through catalyst particles via internally connected pores.

The following examples illustrate formulations of the inventive catalysts and methods of synthesizing and using the catalysts.

### EXEMPLIFICATION

### Example 1

A carrier comprising barium-oxide-doped alumina was prepared by a wet chemical process. 0.80 g of barium was mixed with 10 mL of methoxyethanol to produce a solution of Ba(CH₃OC₂H₄O)₂. This solution was mixed with another solution of 17.37 g aluminum sec-butoxide in 10 mL methoxyethanol. A solution of 1.90 g water in 10 mL methoxyethanol was added dropwise with rapid stirring. Then 7.20 mL of glacial acetic acid was diluted with 5 mL of methoxyethanol and added to the solution.

The sample was dried by venting and purging solvent from the sample heated to 330° C. at 2000 psig. The powder at the top of the dried sample was physically separated from the denser powder at the bottom of the sample. The denser powder was then heated in flowing air at a ramp rate of 3° C./min to 1400° C., held for 5 hours at 1400° C. and then cooled down. The resulting surface area of this sample was 65 m²/g.

### Example 2

A carrier comprising barium hexaaluminate was prepared by a wet chemical process. 8.10 g of Ba was mixed with 180 mL of methoxyethanol to produce a solution of Ba(CH₃OC₂H₄O)₂. This solution was mixed with another solution of 174.6 g aluminum sec-butoxide in 180 mL methoxyethanol. 18.45 g ethyl acetoacetate was added to the solution. 90.1 mL of 1.81 M ammonia in methoxyethanol solution was slowly added to the solution. To this solution was added dropwise a solution of 38.16 g water in 180 mL methoxyethanol. The solution gelled within thirty minutes and the gel was aged for an additional 16 hours at 55° C. to yield a translucent product.

The sample was dried by venting and purging solvent from the sample heated to 330° C. at 2000 psig. The sample was then heated in flowing air at a ramp rate of 3° C./min to 1650° C., held for 5 hours at 1650° C. and then cooled down. The resulting surface area of this sample was 8 m²/g.

### Example 3

A catalyst comprising iridium, platinum and barium hexaaluminate with an Ir:Pt:Ba:Al atomic ratio of 0.85:0.84:1:12 was prepared by impregnating porous barium hexaaluminate granules. The carrier granules were prepared by pelletizing a mixture of 75 wt % barium hexaaluminate powder with a surface area of 6 m²/g with 25 wt % polyethylene glycol. After calcining the pellets at 600° C. in air, the pellets were crushed into granules and sieved to a −12/+20 mesh fraction. An impregnation solution including 0.25 mol/L H₂IrCl₆ and 0.25 mol/L H₂PtCl₆ dissolved in 2-propanol was prepared. An amount of impregnation solution sufficient to fill the pores of the granular carrier was mixed with the granular carrier and then dried at 70° C. The impregnated granules were then heated to 380° C. in air. After cooling, the impregnation and heat-treatment procedure was repeated five times in order to reach the desired catalyst Ir and Pt content. Following the final impregnation, the catalyst was reduced in a flowing stream of hydrogen at 600° C. and then heated to 1650° C. in a flowing stream of argon. The resulting surface area of the catalyst was 4 m²/g.

Three parts by mass of the catalyst were ground and mixed with 1 part AF-M315E, which includes 44.5% by weight stabilized HAN, 44.5% by weight hydroxyethylhydrazine nitrate and 11.0% by weight water. The monopropellant decomposition activity of the catalyst was measured with a temperature-programmed technique in which the catalyst-propellant mixture is slowly heated. The temperature at which a significant reaction exotherm is detected is termed the decomposition onset temperature and is a good measure of the catalytic activity. The mixture was heated at 10° C./min in a differential scanning calorimeter to measure the onset temperature of the decomposition reaction. The onset of the exothermic reaction was observed to be 123° C.

### Example 4

A catalyst of the prior art including 32 wt % Ir supported on aluminum oxide (i.e., a Shell 405 catalyst) was reduced in a flowing stream of hydrogen at 600° C., and then portions of the catalyst were heated to 1000 and 1650° C. in a flowing stream of argon.

Three parts by mass of each sample of catalyst were ground and mixed with 1 part AF-M315E. Each mixture was heated at 10° C./min in a differential scanning calorimeter to measure the onset temperature of the decomposition reaction. The onset of the exothermic reaction and surface area of each catalyst are listed in TABLE I.

TABLE I

| Thermal Treatment | Onset Temperature (° C.) | Surface Area (m²/g) |
|---|---|---|
| None | 90 | 117 |
| 600° C. H₂, 1000° C. Ar | 163 | — |
| 600° C. H₂, 1650° C. Ar | 196 | 0.1 |

### Example 5

A series of catalysts were prepared by impregnating a porous ceramic carrier composed of barium hexaaluminate powder that possessed a surface area of 7 m²/g. Impregnation solutions were prepared by dissolving nitrate and chloride salts in isopropanol. Thirteen impregnations were conducted for each metal salt in order to attain a target loading of 25 wt % based upon the impregnated metal content. These catalysts were then heated to 1000° C. in argon after reducing a portion of each sample in flowing hydrogen at 600° C. and oxidizing a portion of each sample in flowing air at 600° C.

The AF-M315E monopropellant decomposition activity of each catalyst and of the Shell 405 catalyst heated to 1000° C. in argon was determined by measuring the decomposition onset temperature as listed in TABLE II, wherein barium hexaaluminate is abbreviated as “BHA.”

TABLE II

| Metallic | Onset Temperature | Metal Oxide | Onset Temperature |
|---|---|---|---|
| Catalyst | (° C.) | Catalyst | (° C.) |
| Ce/BHA | 186 | CeOₓ/BHA | 148 |
| Co/BHA | 110 | CoOₓ/BHA | 164 |
| Cr/BHA | 162 | CrOₓ/BHA | 160 |
| Cu/BHA | 45 | CuOₓ/BHA | 40 |
| Fe/BHA | 119 | FeOₓ/BHA | 135 |
| Ir/BHA | 162 | IrOₓ/BHA | 172 |
| Nb/BHA | 162 | NbOₓ/BHA | 179 |
| Ni/BHA | 105 | NiOₓ/BHA | 183 |
| V/BHA | 68 | VOₓ/BHA | 92 |
| Shell 405 | 163 | | |

### Example 6

One embodiment of the inventive catalyst includes an active catalytic phase comprising a metal oxide mixed with additional metal oxides to produce an active phase with improved thermal and chemical stability. V₂O₅, with a melting point of 695° C., was mixed and ground with Y₂O₃ and Tm₂O₃ and then heated to 1650° C. in air to produce active catalyst phases of YVO₄ (melting point: 1810° C.), TmVO₄ (melting point: 1800° C.) and Tm₈V₂O₁₇ (melting 1900° C.). Upon reduction in flowing hydrogen at 1100° C., active catalyst phases of YVO₃ and TmVO₃ were produced.

The AF-M315E monopropellant decomposition activities of these unsupported active phases and that of unheated V₂O₅ and V₂O₃ were measured via temperature programmed reaction, with the results summarized in TABLE III.

TABLE III

| Active Phase | Onset Temperature (° C.) |
|---|---|
| V₂O₅ | 72 |
| V₂O₃ | 77 |
| YVO₄ | 168 |
| YVO₃ | 97 |
| TmVO₄ | 154 |
| Tm₈V₂O₁₇ | 156 |
| TmVO₃ | 103 |

### Example 7

A catalyst comprising yttrium oxide, vanadium oxide and barium hexaaluminate with a Y:V:Ba:Al atomic ratio of 0.42:0.42:1:12 was prepared by impregnating porous barium hexaaluminate powder. The barium hexaaluminate powder possessed a surface area of 6 m²/g. An impregnation solution including 0.25 mol/L V₂O₅ dissolved in concentrated HCl was prepared. An amount of impregnation solution sufficient to fill the pores of the carrier was mixed with the carrier and then dried at 60° C. The impregnated carrier was then heated to 380° C. in air. After cooling, the impregnation and heat-treatment procedure was repeated a second time in order to reach the desired catalyst V content. An impregnation solution including 0.22 mol/L Y(NO₃)₃ dissolved in isopropanol was prepared. An amount of impregnation solution sufficient to fill the pores of the carrier was mixed with the carrier and then dried at 60° C. The impregnated carrier was then heated to 380° C. in air. After cooling, the impregnation and heat-treatment procedure was repeated two additional times in order to reach the desired catalyst Y content. Following the final impregnation, the catalyst was oxidized in a flowing stream of air at 600° C. and then heated to 1650° C. in a flowing stream of air.

Three parts by mass of the catalyst were ground and mixed with 1 part AF-M315E. The mixture was heated at 1° C./min in a differential scanning calorimeter to measure the onset temperature of the decomposition reaction. The onset of the exothermic reaction was observed to be 91° C.

### Example 8

A catalyst comprising vanadium oxide supported on barium hexaaluminate with a V:Ba:Al atomic ratio of 0.1:1:12 was prepared by impregnating porous barium hexaaluminate powder. The barium hexaaluminate powder possessed a surface area of 6 m²/g. An impregnation solution including 0.05 mol/L V₂O₅ dissolved in concentrated HCl was prepared. An amount of impregnation solution sufficient to fill the pores of the carrier was mixed with the carrier and then dried at 90° C. The impregnated carrier was then heated to 200° C. in air. After cooling, the impregnation and heat-treatment procedure was repeated a second time in order to reach the desired catalyst V content. Following the final impregnation, the catalyst was oxidized in a flowing stream of air at 600° C. and then heated to 1650° C. in a flowing stream of air.

Three parts by mass of the catalyst was ground and mixed with 1 part AF-M315E. The mixture was heated at 10° C./min in a differential scanning calorimeter to measure the onset temperature of the decomposition reaction. The onset of the exothermic reaction was observed to be 86° C.

### Example 9

A catalyst comprising iridium, platinum and vanadium oxide supported on barium hexaaluminate with an Ir:Pt:V:Ba:Al atomic ratio of 0.36:0.35:0.17:1:12 was prepared by impregnating porous barium hexaaluminate powder. The barium hexaaluminate powder possessed a surface area of 7 m²/g. An impregnation solution comprising 0.25 mol/L V₂O₅ dissolved in concentrated HCl was prepared. An amount of impregnation solution sufficient to fill the pores of the carrier was mixed with the carrier and then dried at 90° C. The impregnated carrier was then heated to 200° C. in air. After cooling, the impregnation and heat-treatment procedure was twice repeated in order to reach the desired catalyst V content. An impregnation solution comprising 0.13 mol/L H₂IrCl₆ and 0.13 mol/L H₂PtCl₆ dissolved in 2-propanol was prepared. An amount of impregnation solution sufficient to fill the pores of the granular carrier was mixed with the granular carrier and then dried at 60° C. The impregnated granules were then heated to 200° C. in air. After cooling, the impregnation and heat-treatment procedure was repeated four times in order to reach the desired catalyst Ir and Pt content. Following the final impregnation, the catalyst was reduced in a flowing stream of hydrogen at 600° C. and then heated to 1650° C. in a flowing stream of argon.

One part by mass of the catalyst was ground and mixed with three parts AF-M315E. The mixture was heated at 10° C./min in a differential scanning calorimeter to measure the onset temperature of the decomposition reaction. The onset of the exothermic reaction was observed to be 107° C.

### Example 10

A catalyst comprising iridium, platinum and vanadium oxide supported on ceria-zirconia with an Ir:Pt:V:Ce:Zr atomic ratio of 0.04:0.04:0.02:0.14:1 was prepared by impregnating porous zirconium oxide powder. The zirconium oxide powder possessed a surface area of 50 m²/g. An impregnation solution comprising 1.1 mol/L Ce(NO₃)₃ dissolved in water was prepared. An amount of impregnation solution sufficient to fill the pores of the carrier was mixed with the carrier and then dried at 90° C. The impregnated carrier was then heated to 200° C. in air. After cooling, the impregnation and heat-treatment procedure was twice repeated in order to reach the desired catalyst Ce content. The impregnated carrier was then heated to 600° C. in air. An impregnation solution comprising 0.25 mol/L V₂O₅ dissolved in concentrated HCl was prepared. An amount of impregnation solution sufficient to fill the pores of the carrier was mixed with the carrier and then dried at 90° C. The impregnated carrier was then heated to 200° C. in air. After cooling, the impregnation and heat-treatment procedure was repeated in order to reach the desired catalyst V content. An impregnation solution comprising 0.13 mol/L H₂IrCl₆ and 0.13 mol/L H₂PtCl₆ dissolved in 2-propanol was prepared. An amount of impregnation solution sufficient to fill the pores of the carrier was mixed with the carrier and then dried at 60° C. The impregnated carrier was then heated to 200° C. in air. After cooling, the impregnation and heat-treatment procedure was repeated five times in order to reach the desired catalyst Ir and Pt content. Following the final impregnation, the catalyst was reduced in a flowing stream of hydrogen at 600° C. and then heated to 1650° C. in a flowing stream of argon.

One part by mass of the catalyst was ground and mixed with three parts AF-M315E. The mixture was heated at 1° C./min in a differential scanning calorimeter to measure the onset temperature of the decomposition reaction. The onset of the exothermic reaction was observed to be 132° C.

### Example 11

The catalyst of Example 9 was heated to 1850° C. in an argon atmosphere. The catalyst was then heated to 1650° C. in a flowing stream of argon.

One part by mass of the catalyst was ground and mixed with three parts AF-M315E. The mixture was heated at 10° C./min in a differential scanning calorimeter to measure the onset temperature of the decomposition reaction. The onset of the exothermic reaction was observed to be 120° C.

### Example 12

The catalyst of Example 3 was loaded into a test stand similar in design to that depicted in FIG. 1. The reaction chamber 10 and catalyst bed 8 were preheated to 800° F., and 0.013 lb/s AF-M315E was then injected into catalyst bed 8 for 10 seconds. The reaction chamber pressure increased to 64 psia and the temperature of the exhaust gas increase to 2400° F. FIG. 2 presents the pressure 18 and temperature 20 trace for this test.

### Example 13

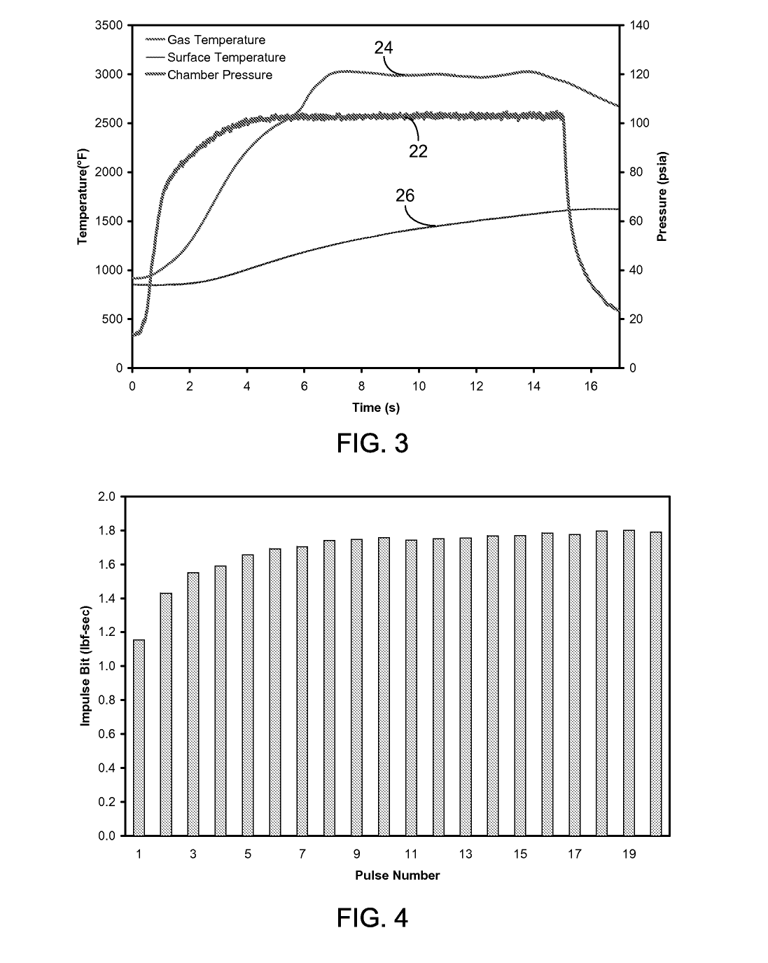

The catalyst of Example 11 was loaded into a test stand similar in design to that depicted in FIG. 1. The reaction chamber 10 and catalyst bed 8 were preheated to 800° F. and 0.018 lb/s AF-M315E was then injected into catalyst bed 8 for 15 seconds. The reaction chamber pressure increased to 103 psia and the temperature of the exhaust gas increased to greater than 3000° F. FIG. 3 presents the chamber pressure 22, gas temperature 24, and surface temperature 26 trace for this test. A characteristic exhaust velocity (defined as the chamber pressure times the thruster throat area divided by the propellant mass flow rate) of 3693 ft/s was calculated for this test.

### Example 14

The catalyst of Example 11 was loaded into a test stand similar in design to that depicted in FIG. 1. The reaction chamber 10 and catalyst bed 8 were preheated to 800° F. and a pulse 0.018 lb/s AF-M315E was then injected into the catalyst bed for 1 second. Following a 9 second interval, another 1 second pulse of AF-M315E was injected into catalyst bed 8. This was repeated until 20 pulses of propellant had been injected. FIG. 4 presents a plot of the resulting impulse bit (defined as the integral of chamber pressure times the thruster throat area) for each of the 20 pulse injections.

### Example 15

The catalyst of Example 11 was loaded into a test stand similar in design to that depicted in FIG. 1. The reaction chamber 10 and catalyst bed 8 were preheated to 800° F. and a series of 15-second injections and 1 -second pulse injections of 0.018 lb/s AF-M315E were introduced into the catalyst bed. A total of 5.6 lb of propellant was decomposed by the catalyst in this test.

In describing embodiments of the invention, specific terminology is used for the sake of clarity. For purposes of description, each specific term is intended to at least include all technical and functional equivalents that operate in a similar manner to accomplish a similar purpose. Additionally, in some instances where a particular embodiment of the invention includes a plurality of system elements or method steps, those elements or steps may be replaced with a single element or step; likewise, a single element or step may be replaced with a plurality of elements or steps that serve the same purpose. Moreover, while this invention has been shown and described with references to particular embodiments thereof, those skilled in the art will understand that various substitutions and alterations in form and details may be made therein without departing from the scope of the invention; further still, other aspects, functions and advantages are also within the scope of the invention. The contents of all references, including issued patents and published patent applications, cited throughout this application are hereby incorporated by reference in their entirety. The appropriate components, processes, and methods of those references may be selected for the invention and embodiments thereof.

What is claimed is:

1. A catalyst comprising 0.05 to 40 weight-% of a catalytic component supported on a porous ceramic carrier that possesses a specific surface area greater than or equal to 1 m²/g after exposure to an oxidizing atmosphere at 1650° C.

2. The catalyst of claim 1, wherein the catalyst possesses a specific surface area greater than or equal to 5 m²/g after exposure to an oxidizing atmosphere at 1650° C.

3. The catalyst of claim 1, wherein the catalyst possesses a specific surface area greater than or equal to 10 m²/g after exposure to an oxidizing atmosphere at 1650° C.

4. The catalyst of claim 1, wherein the porous ceramic carrier comprises a composition selected from the group consisting of metal hexaaluminates, aluminum oxide, lanthanide oxides, zirconium oxide, hafnium oxide, metal zirconates, metal hafnates, metal carbides and combinations thereof.

5. The catalyst of claim 1, wherein the porous ceramic carrier comprises a composition selected from the group consisting of barium hexaaluminate and lanthanum hexaaluminate.

6. The catalyst of claim 1, wherein the catalyst possesses a specific surface area greater than or equal to 1 m²/g after exposure to an oxidizing atmosphere at 1850° C.

7. The catalyst of claim 1, wherein the supported catalytic component comprises a metal selected from the group consisting of Ce, Co, Cr, Cu, Fe, Ir, Nb, Ni, Pt, Re, Ru, Rh, V and mixtures thereof.

8. The catalyst of claim 1, wherein the supported catalytic component comprises a metal selected from the group consisting of Fe, Ir, Pt, Re, V and mixtures thereof.

9. The catalyst of claim 1, wherein the supported catalytic component comprises a metal selected from the group consisting of Ir, Pt, V and mixtures thereof.

10. The catalyst of claim 1, wherein the supported catalytic component comprises vanadium.

11. The catalyst of claim 1, wherein the supported catalytic component comprises a metal oxide selected from the group consisting of oxides of Al, Ce, Co, Cr, Cu, Dy, Er, Eu, Fe, Gd, Hf, Ho, La, Lu, Mg, Mn, Nb, Nd, Ni, Pr, Sc, Sm, Tb, Ti, Tm, V, Y, Yb, Zr and mixtures thereof.

12. The catalyst of claim 1, wherein the supported catalytic component comprises a metal oxide selected from the group consisting of oxides of Ce, Dy, Er, Eu, Fe, Gd, Ho, La, Lu, Nd, Pr, Sc, Sm, Tb, Tm, V, Y, Yb and mixtures thereof.

13. The catalyst of claim 1, wherein the supported catalytic component comprises a metal oxide selected from the group consisting of oxides of Tm, V, Y and mixtures thereof.

14. The catalyst of claim 11, wherein an additional metal selected from the group consisting of Co, Cr, Fe, Ir, Mo, Nb, Ni, Os, Pd, Pt, Re, Ru, Rh, Ta, V, W and mixtures thereof is supported on the catalyst in an amount comprising 0.05 to 40 weight-% of the total catalyst weight.

15. The catalyst of claim 11, wherein an additional metal selected from the group consisting of Ir, Pt, V and mixtures thereof is supported on the catalyst in an amount comprising 0.05 to 40 weight-% of the total catalyst weight.

16. A process for controlled reaction of a liquid propellant with an adiabatic flame temperature of at least 1400° C., the process comprising contacting the liquid propellant with a solid catalyst to produce lower molecular-weight products from the liquid propellant,
wherein the solid catalyst includes 0.05 to 40 weight-% of a catalytic component supported on a porous ceramic carrier, and
wherein the solid catalyst possesses a surface area of at least 10 m²/g after exposure to an oxidizing atmosphere at at least 1400° C.

17. The process of claim 16, wherein the solid catalyst possesses a specific surface area greater than or equal to 50 m²/g after exposure to an oxidizing atmosphere at at least 1400° C.

18. The process of claim 16, wherein the solid catalyst possesses a specific surface area greater than or equal to 1 m²/g after exposure to an oxidizing atmosphere at at least 1650° C.

19. The process of claim 16, wherein the solid catalyst possesses a specific surface area greater than or equal to 5 m²/g after exposure to an oxidizing atmosphere at at least 1650° C.

20. The process of claim 16, wherein the solid catalyst possesses a specific surface area greater than or equal to 10 m²/g after exposure to an oxidizing atmosphere at at least 1650° C.

21. The process of claim 16, wherein the solid catalyst possesses a specific surface area greater than or equal to 1 m²/g after exposure to an oxidizing atmosphere at at least 1850° C.

22. The process of claim 16, wherein the supported catalytic component comprises a metal selected from the group consisting of Ag, Al, Au, Ba, Ca, Ce, Co, Cr, Cu, Dy, Er, Eu, Fe, Gd, Hf, Ho, Ir, La, Lu, Mg, Mn, Mo, Nb, Nd, Ni, Os, Pd, Pr, Pt, Re, Ru, Rh, Sc, Sm, Sr, Ta, Tb, Ti, Tm, V, W, Y, Yb, Zr and mixtures thereof.

23. The process of claim 16, wherein the supported catalytic component comprises a metal selected from the group consisting of Ce, Co, Cr, Cu, Fe, Ir, Nb, Ni, Pt, Re, Ru, Rh, V and mixtures thereof.

24. The process of claim 16, wherein the supported catalytic component comprises a metal selected from the group consisting of Fe, Ir, Pt, Re, V and mixtures thereof.

25. The process of claim 24, wherein the catalyst includes less than 10 weight percent of precious metals.

26. The process of claim 16, wherein the supported catalytic component comprises a metal selected from the group consisting of Ir, Pt, V and mixtures thereof.

27. The process of claim 16, wherein the supported catalytic component comprises vanadium.

28. The process of claim 16, wherein the supported catalytic component comprises a metal oxide selected from the group consisting of oxides of Al, Ce, Co, Cr, Cu, Dy, Er, Eu, Fe, Gd, Hf, Ho, La, Lu, Mg, Mn, Nb, Nd, Ni, Pr, Sc, Sm, Tb, Ti, Tm, V, Y, Yb, Zr and mixtures thereof.

29. The process of claim 28, wherein an additional metal selected from the group consisting of Co, Cr, Fe, Ir, Mo, Nb, Ni, Os, Pd, Pt, Re, Ru, Rh, Ta, V, W and mixtures thereof is supported on the catalyst in an amount comprising 0.05 to 40 weight-% of the total catalyst weight.

30. The process of claim 29, wherein the catalyst includes less than 10 weight percent of precious metals.

31. The process of claim 28, wherein an additional metal selected from the group consisting of Ir, Pt, V and mixtures thereof is supported on the catalyst in an amount comprising 0.05 to 40 weight-% of the total catalyst weight.

32. The process of claim 16, wherein the supported catalytic component comprises a metal oxide selected from the group consisting of oxides of Ce, Dy, Er, Eu, Fe, Gd, Ho, La, Lu, Nd, Pr, Sc, Sm, Tb, Tm, V, Y, Yb and mixtures thereof.

33. The process of claim 16, wherein the supported catalytic component comprises a metal oxide selected from the group consisting of oxides of Tm, V, Y and mixtures thereof.

34. The process of claim 16, wherein the liquid propellant possesses an adiabatic flame temperature greater than 1800° C.

35. The process of claim 16, wherein the liquid propellant comprises hydroxylammonium nitrate, fuel and water.

36. The process of claim 16, wherein the liquid propellant comprises ammonium dinitramide, fuel and water.

37. The process of claim 16, wherein the liquid propellant comprises hydrazinium nitroformate, fuel and water.

38. The process of claim 16, wherein the liquid propellant comprises hydrogen peroxide, fuel and water.

39. The process of claim 16, wherein the liquid propellant comprises nitrous oxide.

40. The process of claim 16, wherein the porous ceramic carrier comprises a composition selected from the group consisting of metal hexaaluminates, aluminum oxides, lanthanide oxides, zirconium oxide, hafnium oxide, metal zirconates, metal hafnates, metal carbides and combinations thereof.

41. The process of claim 16, wherein the porous ceramic carrier comprises a composition selected from the group consisting of barium hexaaluminate and lanthanum hexaaluminate.
